(19) United States
(12) Patent Application Publication
(10) Pub. No.: US 2006/0060042 A1
(43) Pub. Date: Mar. 23, 2006

(54) Device for permitting re-entry of circular saw blade during reciprocating stroke movements

(75) Inventors: Anatoly Gosis, Palatine, IL (US); Richard L. Edwards, Cary, IL (US); Michael D. Loeschen, Hawthorn Woods, IL (US); Ron Gustafson, Woodridge, IL (US)

Correspondence Address: Steven W. Weinrieb;SCHWARTZ & WEINRIEB, Crystal Plaza One, Suite 1109, 2001 Jefferson Davis Highway, Arlington, VA, 22202, US

(73) Assignee: ILLINOIS TOOL WORKS INC.

(21) Appl. No.: 10/945,936

(22) Filed: Sep. 22, 2004

(51) Int. Cl. B27B 11/00; B26D 5/00

(52) U.S. Cl. 83/13; 83/743

(57) ABSTRACT

A tool system comprises a circular saw blade which is adapted to be moved in a reciprocating manner between an elevated, RETRACTED, INOPERATIVE position and a lowered, EXTENDED, OPERATIVE position so as to repeatedly form slits within a packaging structure at a plurality of positions which are defined at predeterminedly spaced locations along the longitudinal extent of the packaging structure. A circular saw blade guide member is disposed adjacent to the outer periphery of the circular saw blade and is movable along with the circular saw blade between its elevated, RETRACTED, INOPERATIVE position and its lowered, EXTENDED, OPERATIVE position. Accordingly, as the circular saw blade is moved from its lowered, EXTENDED, OPERATIVE position back to its elevated, RETRACTED, INOPERATIVE position, the guide member will in effect guide the circular saw blade back through the slit formed within the packaging structure so as to facilitate the retractive movement of the circular saw blade, back through the slit formed within the packaging structure, thereby effectively eliminating the tendency of the circular saw blade to otherwise encounter the edge or wall portions of the packaging structure, which define the slit, in an obstructive manner as the circular saw blade is moved from its lowered EXTENDED, OPERATIVE position to its elevated RETRACTED, INOPERATIVE position in preparation for the performance of a subsequent cutting operation.

### FIELD OF THE INVENTION

The present invention relates generally to a tool system, and more particularly to a new and improved tool system comprising a circular saw blade which is adapted to be moved in a reciprocating manner between an elevated, RETRACTED, INOPERATIVE position and a lowered, EXTENDED, OPERATIVE position so as to repeatedly form slits within a packaging structure at a plurality of longitudinally spaced positions which are defined at predetermined locations throughout the longitudinal extent of the packaging structure, and a circular saw blade guide member which is disposed adjacent to the outer periphery of the circular saw blade and which is movable with the circular saw blade between its elevated, RETRACTED, INOPERATIVE position and its lowered, EXTENDED, OPERATIVE position so as to facilitate the retractive movement of the circular saw blade, back through the slit formed within the packaging structure and without effectively encountering the non-cut portions of the packaging structure in an obstructive manner, as the circular saw blade is moved from its lowered EXTENDED, OPERATIVE position to its elevated RETRACTED, INOPERATIVE position in preparation for the performance of a subsequent cutting operation during which the circular saw blade will form a new slit within the packaging structure at a new longitudinal position defined along the longitudinal extent of the packaging structure.

### BACKGROUND OF THE INVENTION

Various articles, having substantial width, thickness, and length dimensions need to be protected during, for example, the transportation and shipping thereof from their manufacturing facilities to their storage and/or point of sale locations so as to prevent damage from occurring to such articles prior to the purchase of the same by consumers. It is conventional practice to utilize substantially rigid, laminated U-shaped channel structures so as to effectively define composite packaging containers, which encase the articles therewithin, whereby the channel structures can subsequently be secured together by means of, for example, suitable strapping or banding. One type of conventional packaging structure, which has been utilized for the foregoing purposes, is disclosed, for example, within U.S. Pat. No. 4,976,374 which issued to Macaluso on Dec. 11, 1990. More particularly, as disclosed within FIG. 1, which substantially corresponds to FIG. 3 of the aforenoted patent, it is seen that the composite packaging container comprises a substantially U-shaped base unit 10 and a substantially U-shaped cover unit 12. The substantially U-shaped base unit 10 is seen to comprise a base or bottom portion 10a, and a pair of oppositely disposed, upstanding side wall portions or leg members 10b, 10c integrally connected to the base or bottom portion 10a, while the substantially U-shaped cover unit 12 is seen to comprise a cover or top portion 12a, and a pair of oppositely disposed, dependent side wall portions or leg members 12b, 12c integrally connected to the cover or top portion 12a.

Alternatively, in lieu of utilizing two separate packaging structures, such as, for example, the base unit 10 and the cover unit 12, so as to form the composite packaging container, a single packaging structure can be utilized by effectively forming slits within the side wall members of the packaging structure at predetermined locations along the longitudinal extent of the packaging structure. In this manner, the packaging structure is effectively divided into sections which are integrally connected together in an articulated manner whereby the various sections can effectively be bent at predetermined angles with respect to each other so as to effectively form a composite packaging container within which predetermined articles can be packaged. In connection with the fabrication of such articulated packaging structures, it is noted that the slits are conventionally formed within the side wall members of the packaging structure by means of, for example, a circular saw blade which is movable in a reciprocating manner within a vertically oriented plane. More particularly, the circular saw blade is located, for example, at a fixed cutting station, and the packaging structure is moved along its longitudinal extent or axis with respect to the fixed cutting station. Therefore, when a slit is to be formed at a predetermined location within a particular one of the side wall members of the packaging structure, the longitudinal movement of the packaging structure is terminated, and the circular saw blade is moved vertically downwardly from its elevated, RETRACTED, INOPERATIVE position, to its lowered, EXTENDED, OPERATIVE position, at which position the circular saw blade encounters the side wall member of the packaging structure and thereby forms the slit therewithin. Subsequently, when the stroke or movement of the circular saw blade has reached its terminal end point whereby the cutting operation is completed, the circular saw blade is moved vertically upwardly from its lowered, EXTENDED, OPERATIVE position, back to its elevated, RETRACTED, INOPERATIVE position, in preparation for the performance of a subsequent cutting operation. Upon reaching the terminal end point of its upstroke movement, the packaging structure is advanced along its longitudinal extent for a predeterminedly controlled distance, subsequently stopped, and accordingly, the cutting operation cycle may be repeated so as to permit the circular saw blade to cut another slit within the side wall member of the packaging structure at the new position located along the longitudinal or axial extent of the packaging structure.

A problem is often encountered, however, when the circular saw blade undergoes its aforenoted upstroke movement when being returned from its lowered, EXTENDED, OPERATIVE position back to its elevated, RETRACTED, INOPERATIVE position. More particularly, due to a predetermined amount of resiliency inherently characteristic of the paperboard material from which the packaging structure is fabricated, once the circular saw has passed entirely through the side wall member of the packaging structure whereby the particular slit has been completely formed at the predetermined location within the side wall member of the packaging structure, the wall portions of the side wall member of the packaging structure, which effectively define or form the slit, effectively come together or close with respect to each other. Therefore, when the circular saw blade begins its upstroke movement in an attempt to return from its lowered, EXTENDED, OPERATIVE position back to its elevated, RETRACTED, INOPERATIVE position, in lieu of the circular saw blade being able to readily and easily re-enter the slit previously formed within the side wall member of the packaging structure, the circular saw blade will often encounter the wall portions of the side wall member of the packaging structure whereby further movement of the circular saw blade along its upstroke movement is either impeded, or alternatively, the circular saw blade will effectively cut a new slit, or enlarge or damage the slit previously formed within the side wall member of the packaging structure. In either case, the defective packaging structure must be replaced which entails additional production costs in terms of materials and production downtime.

A need therefore exists in the art for a new and improved tool system, comprising a circular saw blade, wherein the circular saw blade will be capable of being moved from its lowered, EXTENDED, OPERATIVE position back to its elevated, RETRACTED, INOPERATIVE position in such a manner that the circular saw blade can in fact be moved backwardly through the slit, previously formed within the packaging structure, in a precisely controlled manner so as to not encounter the wall or edge portions of the packaging structure, which define the slit region, in an obstructive manner, whereby damage to the packaging structure can effectively be prevented.

### SUMMARY OF THE INVENTION

The foregoing and other objectives are achieved in accordance with the teachings and principles of the present invention through the provision of a new and improved tool system comprising a circular saw blade which is adapted to be moved in a reciprocating manner between an elevated, RETRACTED, INOPERATIVE position and a lowered, EXTENDED, OPERATIVE position so as to repeatedly form slits within a packaging structure at a plurality of positions which are defined at predeterminedly spaced locations throughout the longitudinal extent of the packaging structure, and a circular saw blade guide member which is disposed in a coplanar manner adjacent to the outer periphery of the circular saw blade and which is movable along with the circular saw blade between its elevated, RETRACTED, INOPERATIVE position and its lowered, EXTENDED OPERATIVE position. Accordingly, as the circular saw blade is moved from its lowered, EXTENDED, OPERATIVE position back to its elevated, RETRACTED, INOPERATIVE position, the guide member will in effect guide the circular saw blade back through the slit formed within the packaging structure so as to facilitate the retractive movement of the circular saw blade, back through the slit formed within the packaging structure, thereby effectively eliminating the tendency of the circular saw blade to otherwise encounter the edge or wall portions of the packaging structure, which define the slit, in an obstructive manner as the circular saw blade is moved from its lowered EXTENDED, OPERATIVE position to its elevated RETRACTED, INOPERATIVE position in preparation for the performance of a subsequent cutting operation during which the circular saw blade will form a new slit within the packaging structure at a new longitudinal position defined along the longitudinal extent of the packaging structure.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view of a conventional PRIOR ART packaging assembly comprising mating packaging structures;

FIG. 2 is a side elevational view of a tool system comprising a circular saw blade, and a circular saw blade guide member movable with the circular saw blade, wherein the circular saw blade and the circular saw blade guide member are moved between a first elevated RETRACTED, INOPERATIVE position and a second lowered EXTENDED, OPERATIVE position, the circular saw blade, and the circular saw blade guide member, being illustrated at their respective elevated RETRACTED, INOPERATIVE positions; and

FIG. 3 is a side elevational view, similar to that of FIG. 2, showing the tool system comprising the circular saw blade, and the circular saw blade guide member movable with the circular saw blade between the first elevated RETRACTED, INOPERATIVE position and the second lowered EXTENDED, OPERATIVE position, the circular saw blade, and the circular saw blade guide member, being illustrated at their respective lowered EXTENDED, OPERATIVE positions.

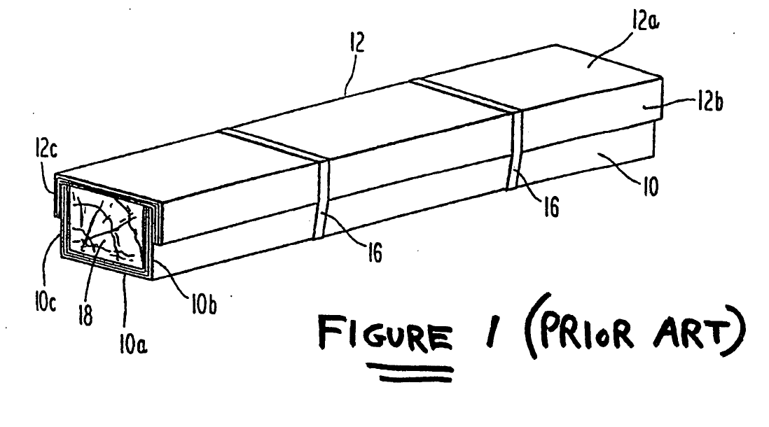

### DETAILED DESCRIPTION OF THE PREFERRED EMBODIMENT

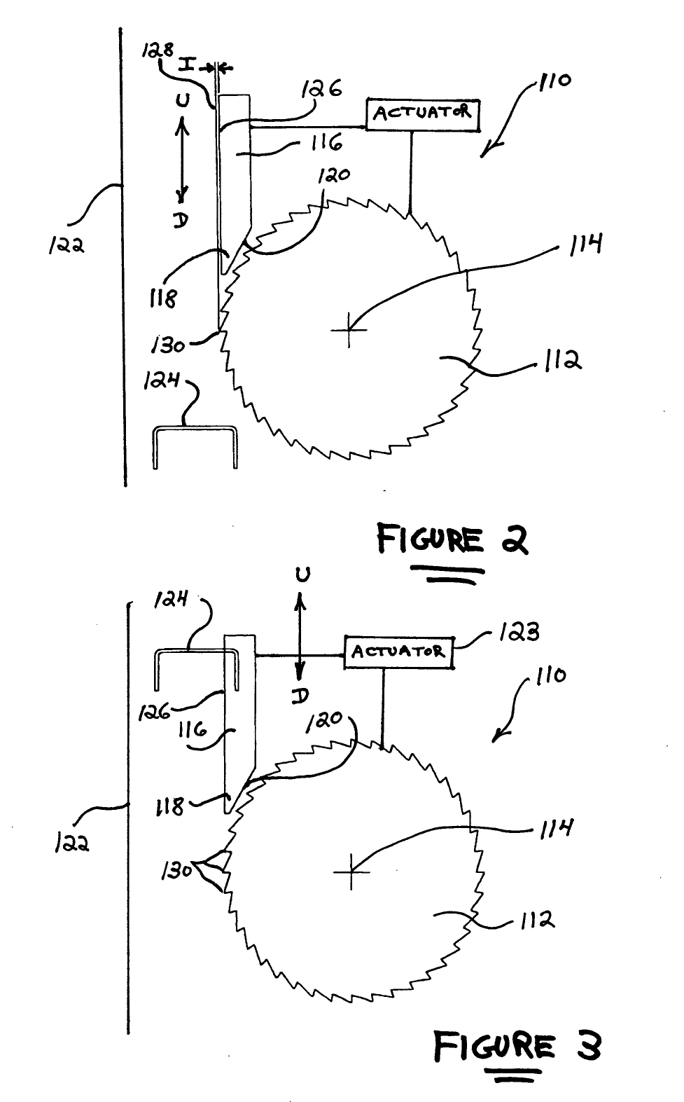

Referring now to the drawings, and more particularly to FIGS. 2 and 3 thereof, a new and improved tool system, constructed in accordance with the principles and teachings of the present invention, is disclosed and is generally indicated by the reference character 110. As can be seen, the tool system 110 comprises a circular saw blade 112 which is adapted to be rotatable around an axis 114, and a circular saw blade guide member 116 which is disposed in a coplanar manner adjacent to an external peripheral portion of the circular saw blade 112 so as to be disposed in close proximity thereto. More particularly, it is seen that the circular saw blade guide member 116 comprises an elongated plate member which has a pointed tip portion 118 that has a substantially right-triangular configuration, wherein the hypotenuse portion or side 120 of the circular saw blade guide member 116 is effectively angled with respect to the longitudinal extent of the circular saw blade guide member 116 so as to be disposed immediately adjacent to the outer periphery of the circular saw blade 112 in a substantially tangential manner. It is to be further appreciated that both the circular saw blade 112 and the circular saw blade guide member 116 are both mounted, at a cutting station defined upon a framework 122, in such a manner that the circular saw blade 112 and the circular saw blade guide member 116 are movable in unison with each other in a vertically oriented reciprocal manner with respect to the framework 122 as schematically indicated by means of the double arrowhead UD. Accordingly, as can be appreciated from a comparison of FIGS. 2 and 3, the movable strokes of the circular saw blade 112 and the circular saw blade guide member 116 are defined between their first, elevated, RETRACTED, INOPERATIVE positions U, as illustrated within FIG. 2, and their second, lowered, EXTENDED, OPERATIVE positions D as illustrated within FIG. 3. Suitable actuator means 123, such as, for example, an air cylinder mechanism, a servo mechanism, or the like, is mounted upon the framework 122 and is operatively connected to both the circular saw blade 112 and the circular saw blade guide member 116 for operatively moving both the circular saw blade 112 and the circular saw blade guide member 116 between the first, elevated, RETRACTED, INOPERATIVE positions U and the second, lowered, EXTENDED, OPERATIVE positions D.

More particularly, when the circular saw blade 112 and the circular saw blade guide member 116 are disposed at their first, elevated, RETRACTED, INOPERATIVE positions U, the circular saw blade 112 and the circular saw blade guide member 116 will both be located vertically above a packaging structure 124 within which a slit is to be formed by means of the circular saw blade 112, however, when the circular saw blade 112 and the circular saw blade guide member 116 are disposed at their second, lowered, EXTENDED, OPERATIVE positions D, only the circular saw blade 112 will have passed entirely through the packaging structure 124 and will now be disposed vertically beneath the packaging structure 124. Conversely, however, in accordance with the unique and novel principles and teachings of the present invention, while the vertically lower portion of the circular saw blade guide member 116, including the pointed tip portion 118 disposed immediately adjacent to the outer periphery of the circular saw blade 112, have correspondingly passed through the slit which has been previously formed within the packaging structure 124 by means of the circular saw blade 112, the vertically upper portion of the circular saw blade guide member 116 remains disposed within the slit which has been formed within the packaging structure 124 by means of the circular saw blade 112.

Therefore, as can readily be appreciated still further, as a result of the upper portion of the circular saw blade guide member 116 being disposed within the slit which has been previously formed within the packaging structure 124 by means of the circular saw blade 112 when the circular saw blade 112 and the circular saw blade guide member 116 have both been moved from their first, elevated, RETRACTED, INOPERATIVE positions U, to their second, lowered, EXTENDED, OPERATIVE positions D, the upper portion of the circular saw blade guide member 116 effectively maintains the slit, which has been previously formed within the packaging structure 124 by means of the circular saw blade 112, in an open or non-collapsed position or state. Accordingly, when the circular saw blade 112 and the circular saw blade guide member 116 are to be returned to their first, elevated, RETRACTED, INOPERATIVE positions U from their second, lowered, EXTENDED, OPERATIVE positions D, since the circular saw blade guide member 116 is already disposed within the slit, which has been previously formed within the packaging structure by means of the circular saw blade 112, then when the upstroke movements of the circular saw blade guide member 116 and the circular saw blade 112 are commenced, the entire longitudinal extent of the circular saw blade guide member 116 will of course simply continue to pass through the slit defined within the packaging structure 124 by means of the circular saw blade 112.

In addition, in view of the close proximity defined between the angled hypotenuse side portion 120 of the circular saw blade guide member 116, and the outer peripheral edge portion of the circular saw blade 112, the outer peripheral edge portion of the circular saw blade 112 will effectively and immediately follow, and be guided by, the pointed tip portion 118 of the circular saw blade guide member 116 so as to readily and easily re-enter the slit, previously formed within the packaging structure 124 by means of the circular saw blade 112, and thereby pass through the slit portion defined within the packaging structure 124 without encountering any non-slit solid portion of the packaging structure 124, such as, for example, the side wall edge portions of the packaging structure 124 which effectively define the slit formed within the packaging structure 124. The circular saw blade guide member 116 and the circular saw blade 112 may then once again be disposed at their first, elevated, RETRACTED, INOPERATIVE positions U in preparation for the performance of a subsequent cutting operation by means of which a new or additional slit may be formed at a different location along the longitudinal extent of the packaging structure after the packaging structure has been linearly moved along its longitudinal extent relative to the cutting station defined upon the framework 122 by means of the circular saw blade 112.

It is to be additionally noted that, in order to facilitate the aforenoted re-entry movement of the circular saw blade 112 back through the slit, previously formed within the packaging structure 124 by means of the circular saw blade 112, wherein the circular saw blade 112 of course has a predetermined thickness dimension, the circular saw blade guide member 116 will preferably have a predetermined thickness dimension which is substantially equal to or just slightly less than the predetermined thickness dimension of the circular saw blade 112. Furthermore, the circular saw blade guide member 116 may be slightly tapered along the longitudinal extent thereof, with the relatively larger or thicker portion of the circular saw blade guide member 116 being defined upon the pointed end portion 118 of the circular saw blade guide member 116 which is located immediately adjacent to the circular saw blade 112, while the relatively smaller or thinner portion of the circular saw blade guide member 116 is defined upon the opposite end portion of the circular saw blade guide member 116. In this manner, the relatively smaller or thinner portion of the circular saw blade guide member 116, which is defined upon the end portion of the circular saw blade guide member 116 which is located more remote from the circular saw blade 112 than the pointed end portion 118 of the circular saw blade guide member 116, will nevertheless sufficiently maintain the slit, previously formed within the packaging structure 124 by means of the circular saw blade 112, in its open or non-collapsed state.

However, as the circular saw blade 112 and the circular saw blade guide member 116 are moved so as to be returned from their second, lowered, EXTENDED, OPERATIVE positions D back to their first, elevated, RETRACTED, INOPERATIVE positions U, the tapered structure, characteristic of the circular saw blade guide member 116, will effectively enlarge the size of the slit, previously formed within the packaging structure 124 by means of the circular saw blade 112, ever so slightly so as to further facilitate the re-entrance of the circular saw blade 112 back into the slit, previously formed within the packaging structure 124 by means of the circular saw blade 112, whereby the circular saw blade 112 can then proceed entirely through the slit packaging structure 124 so as to be readily disposed at or again achieve its first, elevated, RETRACTED, INOPERATIVE position U. Still yet further, the pointed tip portion 118 of the circular saw blade guide member 116 may also be tapered or chamfered along the hypotenuse or angle edge portion 120 so as to likewise facilitate the entry of the pointed tip portion of the circular saw blade guide member 116 into and through the slit, previously formed within the packaging structure 124 by means of the circular saw blade 112, when the circular saw blade 112 and the circular saw blade guide member 116 are being moved downwardly from their first, elevated, RETRACTED, INOPERATIVE positions U toward their second, lowered, EXTENDED, OPERATIVE positions D. It is lastly noted that in order to effectively prevent the circular saw blade guide member 116 from unintentionally or undesirably encountering the internal or blind edge portion of the slit formed within the packaging structure 124 by means of the circular saw blade 112, the longer longitudinal edge portion 126 of the circular saw blade guide member 116 is radially inset or offset from the vertically oriented tangential cutting locus 128 of the circular saw blade 112, as defined by means of the cutting edge portions of the teeth 130 of the circular saw blade 112, by means of a predetermined amount denoted I.

Thus, it may be seen that in accordance with the principles and teachings of the present invention, there has been provided a new and improved tool system which comprises a circular saw blade which is adapted to be moved in a reciprocating manner between an elevated, RETRACTED, INOPERATIVE position and a lowered, EXTENDED, OPERATIVE position so as to repeatedly form slits within a packaging structure at a plurality of positions which are defined at predeterminedly spaced locations throughout the longitudinal extent of the packaging structure. A circular saw blade guide member is disposed adjacent to the outer periphery of the circular saw blade and is movable along with the circular saw blade between its elevated, RETRACTED, INOPERATIVE position and its lowered, EXTENDED, OPERATIVE position. Accordingly, as the circular saw blade is moved from its lowered, EXTENDED, OPERATIVE position back to its elevated, RETRACTED, INOPERATIVE position, the guide member will in effect guide the circular saw blade back through the slit formed within the packaging structure so as to facilitate the retractive movement of the circular saw blade, back through the slit formed within the packaging structure, thereby effectively eliminating the tendency of the circular saw blade to otherwise encounter the edge or wall portions of the packaging structure, which define the slit, in an obstructive manner as the circular saw blade is moved from its lowered EXTENDED, OPERATIVE position to its elevated RETRACTED, INOPERATIVE position in preparation for the performance of a subsequent cutting operation during which the circular saw blade will form a new slit within the packaging structure at a new longitudinal position defined along the longitudinal extent of the packaging structure.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A tool system for forming slits within packaging structures, comprising:
a cutting mechanism reciprocally mounted for movement between a first position, at which said cutting mechanism will be disposed upon a first side of the packaging structure, and a second position, at which said cutting mechanism will be disposed upon a second side of the packaging structure, such that said cutting mechanism forms a slit within the packaging structure as said cutting mechanism moves from said first position, passes through the packaging structure, and reaches said second position;
means for moving said cutting mechanism from said first position, through the packaging structure, and to said second position; and
guide means, movable with said cutting mechanism and adapted to be disposed within the slit, formed within the packaging structure by said cutting mechanism, when said cutting mechanism has passed through the packaging structure and is disposed at said second position, for guiding said cutting mechanism back through the slit, formed within the packaging structure by said cutting mechanism, as said cutting mechanism is moved back from said second position to said first position.

2. The tool system as set forth in claim 1, wherein:
said cutting mechanism comprises a circular saw blade rotatable about an axis and having an outer peripheral edge portion upon which a plurality of cutting teeth are located; and
said guide means comprises an elongated plate member disposed in a coplanar manner adjacent to said outer peripheral edge portion of said circular saw blade.

3. The tool system as set forth in claim 2, wherein:
said elongated plate member has a pointed tip portion which has a substantially right-triangular configuration such that the angled hypotenuse edge portion of said elongated plate member is disposed immediately adjacent to said outer peripheral edge portion of said circular saw blade in a substantially tangential manner.

4. The tool system as set forth in claim 2, wherein:
said circular saw blade has a first predetermined thickness dimension; and
said elongated plate member has a second predetermined thickness dimension which is not greater than said first predetermined thickness dimension of said circular saw blade.

5. The tool system as set forth in claim 1, wherein:
said cutting mechanism and said guide means, movable with said cutting mechanism, are reciprocally movable in vertically oriented directions between said first position and said second position.

6. The tool system as set forth in claim 2, wherein:
said outer peripheral edge portion of said circular saw blade, as defined by said cutting teeth of said circular saw blade, defines a tangential locus; and
an elongated edge portion of said elongated plate member is inset radially inwardly from said tangential locus of said circular saw blade such that said elongated edge portion of said elongated plate does not encounter an internal blind edge portion of the slit formed within the packaging structure by said cutting teeth of said circular saw blade.

7. Apparatus for forming slits within packaging structures, comprising:
a framework;
a cutting mechanism reciprocally mounted upon said framework for movement between a first position, at which said cutting mechanism will be disposed upon a first side of the packaging structure, and a second position, at which said cutting mechanism will be disposed upon a second side of the packaging structure, such that said cutting mechanism forms a slit within the packaging structure as said cutting mechanism moves from said first position, passes through the packaging structure, and reaches said second position;
means for moving said cutting mechanism from said first position, through the packaging structure, and to said second position; and
guide means, movably mounted upon said framework along with said cutting mechanism and adapted to be disposed within the slit, formed within the packaging structure by said cutting mechanism, when said cutting mechanism has passed through the packaging structure and is disposed at said second position, for guiding said cutting mechanism back through the slit, formed within the packaging structure by said cut-ting mechanism, as said cutting mechanism is moved back from said second position to said first position.

8. The apparatus as set forth in claim 7, wherein:
said cutting mechanism comprises a circular saw blade rotatable about an axis and having an outer peripheral edge portion upon which a plurality of cutting teeth are located; and
said guide means comprises an elongated plate member disposed in a coplanar manner adjacent to said outer peripheral edge portion of said circular saw blade.

9. The apparatus as set forth in claim 8, wherein:
said elongated plate member has a pointed tip portion which has a substantially right-triangular configuration such that the angled hypotenuse edge portion of said elongated plate member is disposed immediately adjacent to said outer peripheral edge portion of said circular saw blade in a substantially tangential manner.

10. The apparatus as set forth in claim 8, wherein:
said circular saw blade has a first predetermined thickness dimension; and
said elongated plate member has a second predetermined thickness dimension which is not greater than said first predetermined thickness dimension of said circular saw blade.

11. The apparatus as set forth in claim 7, wherein:
said cutting mechanism and said guide means, movable with said cutting mechanism, are reciprocally movable in vertically oriented directions between said first position and said second position.

12. The apparatus as set forth in claim 8, wherein:
said outer peripheral edge portion of said circular saw blade, as defined by said cutting teeth of said circular saw blade, defines a tangential locus; and
an elongated edge portion of said elongated plate member is inset radially inwardly from said tangential locus of said circular saw blade such that said elongated edge portion of said elongated plate does not encounter an internal blind edge portion of the slit formed within the packaging structure by said cutting teeth of said circular saw blade.

13. A method for forming slits within packaging structures, comprising the steps of:
reciprocally mounting a cutting mechanism for movement between a first position, at which said cutting mechanism will be disposed upon a first side of the packaging structure, and a second position, at which said cutting mechanism will be disposed upon a second side of the packaging structure;
moving said cutting mechanism from said first position, through the packaging structure, and to said second position so as to form a slit within the packaging structure as said cutting mechanism moves from said first position, through the packaging structure, and reaches said second position;
reciprocally mounting a guide means for movement with said cutting mechanism such that when said cutting mechanism is disposed at said first position, said guide means is disposed upon the first side of the packaging structure, while when said cutting mechanism is disposed at said second position, said guide means is disposed within the slit formed within the packaging structure by said cutting mechanism; and
moving said cutting mechanism back from said second position, toward said first position, such that said guide means, previously disposed within the slit formed within the packaging structure by said cutting mechanism, will guide said cutting mechanism through the slit defined within the packaging structure so as to permit said cutting mechanism to re-enter the slit defined within the packaging structure, to pass through the slit defined within the packaging structure, and to reach said first position in preparation for the performance of a subsequent cutting operation by means of which another slit can be formed within the packaging structure at a different location within the packaging structure.

14. The method as set forth in claim 13, further comprising the steps of:
providing said cutting mechanism as a circular saw blade rotatable about an axis and having an outer peripheral edge portion upon which a plurality of cutting teeth are located; and
providing said guide means as an elongated plate member which is disposed in a coplanar manner adjacent to said outer peripheral edge portion of said circular saw blade.

15. The method as set forth in claim 14, further comprising the step of:
providing said elongated plate member with a pointed tip portion which has a substantially right-triangular configuration such that the angled hypotenuse edge portion of said elongated plate member is disposed immediately adjacent to said outer peripheral edge portion of said circular saw blade in a substantially tangential manner.

16. The method as set forth in claim 14, further comprising the steps of:
providing said circular saw blade with a first predetermined thickness dimension; and
providing said elongated plate member with a second predetermined thickness dimension which is not greater than said first predetermined thickness dimension of said circular saw blade.

17. The method as set forth in claim 13, further comprising the step of:
reciprocally moving said cutting mechanism and said guide means, movable with said cutting mechanism, in vertically oriented directions between said first position and said second position.

18. The method as set forth in claim 14, further comprising the steps of:
using said outer peripheral edge portion of said circular saw blade, as defined by said cutting teeth of said circular saw blade, to define a tangential locus; and
positioning an elongated edge portion of said elongated plate member in a radially inwardly inset manner from said tangential locus of said circular saw blade such that said elongated edge portion of said elongated plate does not encounter an internal blind edge portion of the slit formed within the packaging structure by said cutting teeth of said circular saw blade.
